(19) United States
(12) Patent Application Publication
(10) Pub. No.: US 2024/0220870 A1
(43) Pub. Date: Jul. 4, 2024

(54) MOBILE TERMINAL, DISPLAY METHOD FOR DIGITAL TICKET, AND NON-TRANSITORY STORAGE MEDIUM

(71) Applicant: TOYOTA JIDOSHA KABUSHIKI KAISHA, Toyota-shi (JP)

(72) Inventor: Hiroshi MAJIMA, Tokyo (JP)

(73) Assignee: TOYOTA JIDOSHA KABUSHIKI KAISHA, Toyota-shi (JP)

(21) Appl. No.: 18/394,618

(22) Filed: Dec. 22, 2023

(30) Foreign Application Priority Data
Dec. 28, 2022 (JP) 2022-211458

(51) Int. Cl. G06Q 10/02; G06Q 30/0251

(52) U.S. Cl. CPC G06Q 10/02; G06Q 30/0265; G06Q 50/40

(57) ABSTRACT

A mobile terminal carried by a user includes a display configured to display both a digital ticket to use transportation and an advertisement, and a controller configured to control the display. The controller is configured to control the display such that the digital ticket is displayed. The controller is configured to, when a predetermined condition indicating that the user is getting on or off the transportation is satisfied, control the display such that a display area of the advertisement reduces as compared to when the predetermined condition is not satisfied.

### CROSS-REFERENCE TO RELATED APPLICATION

This application claims priority to Japanese Patent Application No. 2022-211458 filed on Dec. 28, 2022, incorporated herein by reference in its entirety.

### BACKGROUND

### 1. Technical Field

The disclosure relates to a mobile terminal, a display method for a digital ticket, and a non-transitory storage medium.

### 2. Description of Related Art

Introduction of digital tickets has been proceeding in public transportation, such as electric trains and buses. Digital tickets are advantageous for business operators in terms of eliminating the necessity to ship paper tickets and making it possible to reduce cost. Digital tickets are also advantageous for users in terms of smooth getting on and off, reducing losses because of no need to carry paper tickets, simple procedure from purchase to receipt, and the like.

When a digital ticket is used, a ticket face showing terms of use, QR Code (registered trademark), and the like are displayed on a screen (display) of a mobile terminal of a user. It is presumable to place an advertisement in addition to a digital ticket on the screen of a mobile terminal. For example, Japanese Unexamined Patent Application Publication No. 2020-046931 (JP 2020-046931 A) describes to display an advertisement when a user gets off transportation or passes through a ticket gate to check a ticket for transportation (see paragraphs 0056 to 0059).

### SUMMARY

Displaying an advertisement is not only advantageous for a business operator from the viewpoint of advertising revenue but also advantageous for a user to make it possible to get information on commercial products and/or services in which the user is interested. On the assumption of actual use scenes of digital tickets, it is desired to achieve both the advantage of digital tickets and the advantage of advertisement display.

The disclosure achieves both the advantage of a digital ticket and the advantage of advertisement display.

A first aspect of the disclosure provides a mobile terminal carried by a user. The mobile terminal includes a display configured to display both a digital ticket to use transportation and an advertisement, and a controller configured to control the display. The controller is configured to control the display such that the digital ticket is displayed. The controller is configured to, when a predetermined condition indicating that the user is getting on or off the transportation is satisfied, control the display such that a display area of the advertisement reduces as compared to when the predetermined condition is not satisfied.

In the first aspect, the controller may be configured to, when the predetermined condition is not satisfied, control the display such that both the digital ticket and the advertisement are displayed, and, when the predetermined condition is satisfied, control the display such that the digital ticket is displayed and the advertisement is not displayed.

In the above configuration, when the predetermined condition is satisfied (when the user is getting on or off the transportation), the display area of the advertisement reduces (or is not displayed). Thus, the influence that the advertisement can exert on the visibility of the digital ticket is reduced, and the visibility of the digital ticket improves, so it is easy for the user to show the digital ticket and for a crew to check the digital ticket. On the other hand, when the predetermined condition is not satisfied (when the user is not getting on or off the transportation), the advertisement is displayed with a larger area, so it is easy for the user to check the details of the advertisement. Thus, according to the above configuration, it is possible to achieve both the advantage of digital ticket and the advantage of advertisement display.

In the first aspect, the mobile terminal may further include a location detector configured to detect location information of the mobile terminal. The controller may be configured to determine that the predetermined condition is satisfied when a moving speed of the mobile terminal is lower than a reference speed, and determine that the predetermined condition is not satisfied when the moving speed of the mobile terminal is higher than the reference speed.

In the first aspect, the mobile terminal may include a sensor configured to detect rotational motion of the mobile terminal. The controller may be configured to determine that the predetermined condition is satisfied when user operation that the user shows the digital ticket to a crew of the transportation is detected based on a detection result of the sensor, and determine that the predetermined condition is not satisfied when the user operation is not detected.

In the first aspect, the mobile terminal may further include a location detector configured to detect location information of the mobile terminal. The controller may be configured to determine that the predetermined condition is satisfied when the location detector detects that the mobile terminal is closer than a predetermined distance to a getting on/off point of the transportation, and determine that the predetermined condition is not satisfied when the location detector does not detect that the mobile terminal is closer than the predetermined distance to the getting on/off point.

With the above configuration, it is possible to appropriately determine whether the predetermined condition is satisfied, that is, whether the user is getting on or off the transportation.

A second aspect of the disclosure provides a display method for a digital ticket for a user to use transportation. The display method includes a displaying step of displaying both the digital ticket and an advertisement on a display of a mobile terminal. The displaying step includes, when a predetermined condition indicating that the user is getting on or off the transportation is satisfied, reducing a display area of the advertisement as compared to when the predetermined condition is not satisfied.

A third aspect of the disclosure provides a non-transitory storage medium storing instructions executable on one or multiple processors in a mobile terminal and causing the one or multiple processors to execute the display method according to the second aspect.

According to the second and third aspects of the disclosure it is possible to achieve both the advantage of digital ticket and the advantage of advertisement display.

According to the first, second, and third aspects of the disclosure, it is possible to achieve both the advantage of digital ticket and the advantage of advertisement display.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that schematically shows the overall configuration of a digital ticket management system according to an embodiment of the disclosure;

FIG. 2 is a block diagram that shows an example of the configuration of a server;

FIG. 3 is a block diagram that shows an example of the configuration of a mobile terminal;

FIG. 4 is a view that shows an example of a display mode of a display of the mobile terminal;

FIG. 5 is a view that shows an example of a display mode of the display of the mobile terminal after being switched; and

FIG. 6 is a flowchart that shows an example of the procedure of a process of displaying a digital ticket according to the embodiment.

### DETAILED DESCRIPTION OF EMBODIMENTS

Hereinafter, an embodiment of the disclosure will be described in detail with reference to the accompanying drawings. Like reference signs denote the same or corresponding portions in the drawings, and the description thereof will not be repeated.

### EMBODIMENT

### System Configuration

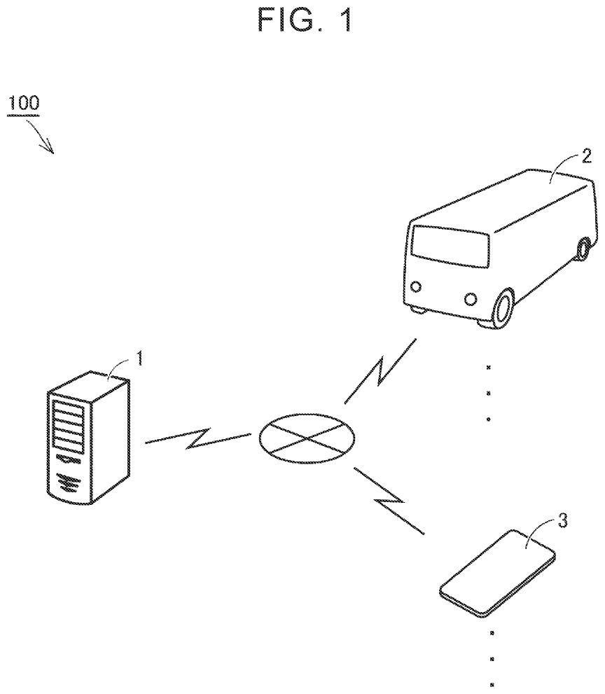

FIG. 1 is a diagram that schematically shows the overall configuration of a digital ticket management system according to the embodiment of the disclosure. A digital ticket management system 100 includes a server 1, a plurality of vehicles (in this example, buses) 2 for public transportation, and a plurality of mobile terminals 3. Public transportation is not limited to buses. Public transportation may be railroads, may be ships, or may be a combination of them.

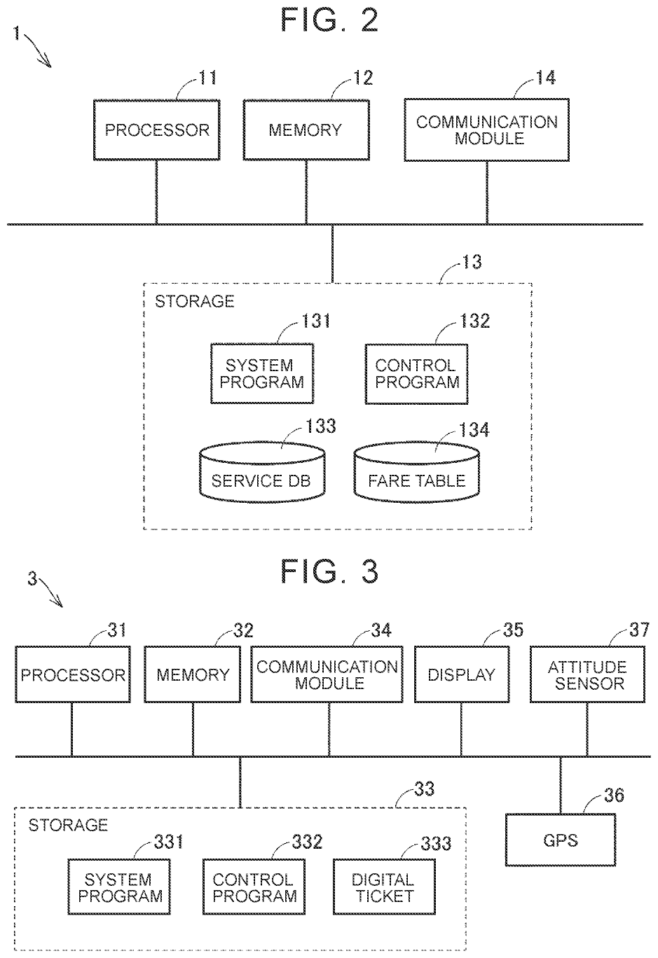

FIG. 2 is a block diagram that shows an example of the configuration of the server 1. The server 1 is typically a business operator server operated by a business operator of the buses 2. The server 1 includes, for example, a processor 11, a memory 12, a storage 13, and a communication module 14.

The processor 11 is, for example, a microprocessor, such as a central processing unit (CPU) and a micro-processing unit (MPU). The memory 12 is a volatile memory, such as a random access memory (RAM). The processor 11 implements various processes by reading a system program 131 and a control program 132 (described later), expanding the system program 131 and the control program 132 on the memory 12, and running the system program 131 and the control program 132.

The storage 13 is a rewritable nonvolatile memory, such as a hard disk drive (HDD), a solid state drive (SSD), and a flash memory. The system program 131 including an operating system (OS), the control program 132 including a computer-readable code necessary for control operation, a service database 133, and a fare table 134 are stored in the storage 13. The service database 133 stores a service schedule and a service history of each of the buses 2. The fare table 134 manages fares (fares of digital tickets) in a service route of each of the buses 2.

The communication module 14 includes a communication interface with a network, such as the Internet. The communication module 14 is configured to be capable of bidirectionally communicating with devices (such as the buses 2 and the mobile terminals 3) outside the server 1.

FIG. 3 is a block diagram that shows an example of the configuration of each of the mobile terminals 3. The mobile terminal 3 is a terminal carried by a user (passenger) who uses the buses 2 and is, for example, a smartphone, a tablet, or a smart watch. The mobile terminal 3 may be a notebook personal computer (PC). The mobile terminal 3 includes, for example, a processor 31, a memory 32, a storage 33, a communication module 34, a display 35, a global positioning system (GPS) module, and an attitude sensor 37.

The processor 31 is, for example, a microprocessor, such as a CPU and an MPU. The memory 32 is a volatile memory, such as a RAM. The processor 31 implements various processes by reading a system program 331 and a control program 332 (described later), expanding the system program 331 and the control program 332 on the memory 32, and running the system program 331 and the control program 332.

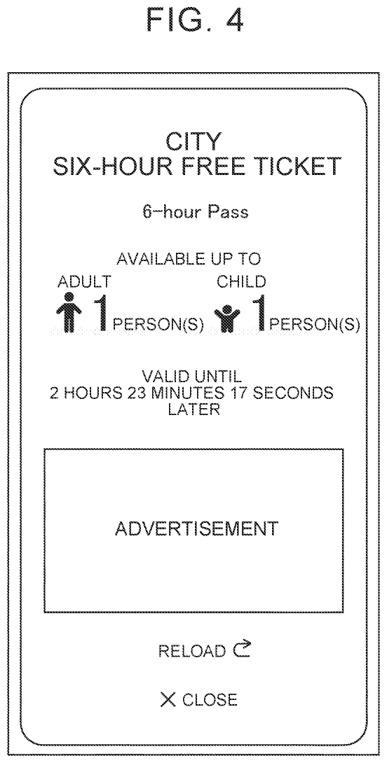

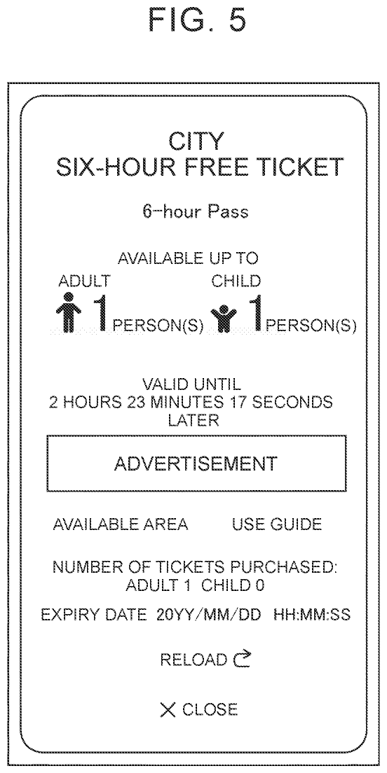

The storage 33 is a rewritable nonvolatile memory, such as a flash memory. A system program 331 including an OS, a control program 332 including a computer-readable code necessary for control operation, and a digital ticket 333 are stored in the storage 33. The digital ticket 333 will be described with reference to FIG. 4 and FIG. 5.

The communication module 34 includes a communication interface that conforms with a wireless communication standard. The wireless communication standard may be long term evolution (LTE), such as 4G and 5G, may be a wireless local area network (LAN), such as Wireless Fidelity (Wi-Fi), or may be both of them. The communication module 34 is configured to be capable of bidirectionally communicating with the server 1.

The display 35 is a mobile display, such as organic electroluminescence (EL) and liquid crystal. The display 35 is configured to display various pieces of information in accordance with a control instruction from the processor 31. In this example, the display 35 is a touch panel display capable of receiving input operation from the user.

The GPS module 36 acquires information indicating a current location of the mobile terminal 3 (GPS information) based on signals from a plurality of artificial satellites, and outputs the GPS information to the processor 31. The mobile terminal 3 may include a beacon receiver (not shown) instead of or in addition to the GPS module 36. The GPS module 36 and/or the beacon receiver may be regarded as an example of the location detector according to the aspect of the disclosure.

The attitude sensor 37 is, for example, a triaxial acceleration sensor, a triaxial gyro sensor, or a magnetic field sensor. The attitude sensor 37 detects the attitude (rotational motion) of the mobile terminal 3 and outputs the detection result to the processor 31. The attitude sensor 37 may be regarded as an example of the sensor according to the aspect of the disclosure.

The control program 332 (application software) for purchasing and displaying the digital ticket 333 is installed in the mobile terminal 3. The user is able to purchase a desired digital ticket 333 in a service route of any one of the buses 2 by operating the mobile terminal 3. The user is also able to show a crew (such as a driver) of the bus 2 the digital ticket 333 when getting on or off the bus 2 (when getting on the bus 2 or when getting off the bus 2) by operating the mobile terminal 3 to display the face of the digital ticket 333 on the display 35. Thus, the user is able to prove that the user him or herself (and the family of the user or the like) is a valid passenger.

### Digital Ticket and Displaying Advertisement

FIG. 4 is a view that shows an example of a display mode of the display 35 of the mobile terminal 3. The digital ticket 333 is displayed on the display 35. As shown in FIG. 4, the digital ticket 333 contains, for example, an available range (in this example, within a city), a term of validity (in this example, six hours) and a remaining time (in this example, more than two hours) of the digital ticket 333, and the numbers of adults and/or children (in this example, one of each). However, the type of the digital ticket 333 is not limited to a free pass as shown in FIG. 4, and a selected type can be used.

Not only the digital ticket 333 but also an advertisement is displayed on the mobile terminal 3. When the user touches a display area of the advertisement, the mobile terminal 3 is connected to an external site of an advertiser, and the screen shifts to show more detailed content of the advertisement.

Displaying such an advertisement is not only advantageous for a business operator from the viewpoint of advertising revenue but also advantageous for a user to make it possible to get information on commercial products and/or services in which the user is interested. On the assumption of actual use scenes of a digital ticket 333, it is desired to achieve both the advantage of the digital ticket 333 and the advantage of advertisement display.

In the present embodiment, a display mode of the digital ticket 333 and an advertisement is switched according to a user operation to the mobile terminal 3 and/or a travel situation of the bus 2. More specifically, when the user is not getting on or off the bus 2 (typically, while the bus 2 is traveling), not only the digital ticket 333 but also an advertisement is displayed with a normal size. As a result, the advantages of both the digital ticket 333 and advertisement display are obtained. In contrast, when the user is getting on or off the bus 2, the display mode of the digital ticket 333 and the advertisement is switched such that the digital ticket 333 is displayed and the advertisement is displayed with a size smaller than a normal size.

FIG. 5 is a view that shows an example of a display mode of the display 35 of the mobile terminal 3 after being switched. When the user gets on or off the bus 2, the display area of the advertisement reduces as shown in FIG. 5. As a result, the visibility of the digital ticket 333 improves as compared to FIG. 4. Thus, an operation that the user shows the digital ticket 333 to a crew and the crew checks the digital ticket 333 is easy. It is also possible to reduce a shift to an external site not intended by the user, due to, for example, an operation error that the user erroneously touches the advertisement on the touch panel.

In the example of FIG. 5, an advertisement is displayed also when the user gets on or off the bus 2. Alternatively, an advertisement does not need to be displayed only when the user gets on or off In other words, displaying an advertisement may be temporarily stopped. The phrase “the display area of the advertisement reduces” in the aspect of the disclosure also includes not displaying an advertisement (stopping display of an advertisement).

### Flow of Process

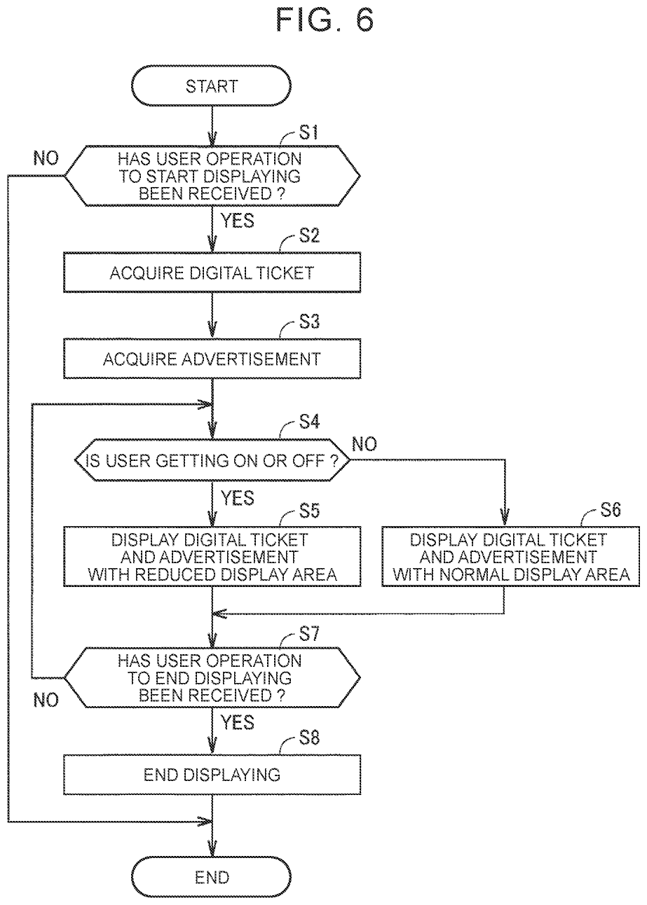

FIG. 6 is a flowchart that shows an example of the procedure of a process of displaying a digital ticket 333 according to the present embodiment. The process shown in the flowchart is called from a main routine (not shown) and executed when a predetermined condition is satisfied (for example, at predetermined intervals). Steps are implemented through software processing by the processor 31 of the mobile terminal 3 (hereinafter, simply referred to as mobile terminal 3). Alternatively, steps may be implemented by hardware (such as an electrical circuit and large scale integration (LSI)) disposed in the processor 31. Hereinafter, “step” is abbreviated as “S”.

In advance of the process described below, assuming a situation in which a procedure to purchase the digital ticket 333 is complete as a result of a user operation to the mobile terminal 3.

In S1, the mobile terminal 3 determines whether the display 35 with a touch panel has received a user operation to start displaying the digital ticket 333 (a user operation to make a request to display the digital ticket 333). When the mobile terminal 3 has not received the user operation (NO in S1), the mobile terminal 3 ends the series of processes. When the mobile terminal 3 has received the user operation (YES in S1), the mobile terminal 3 advances the process to S2.

In S2, the mobile terminal 3 acquires the digital ticket 333. The mobile terminal 3 may read the digital ticket 333 stored in the storage 33 of the mobile terminal 3. Alternatively, the mobile terminal 3 may receive the digital ticket 333 by means of communication with the server 1. The mobile terminal 3 may read part of the digital ticket 333 while receiving another part of information, such as an expiry date, by means of communication with the server 1.

In S3, the mobile terminal 3 acquires an advertisement through communication with the server 1. The mobile terminal 3 may acquire an advertisement according to GPS information of the mobile terminal 3. The order of the process of S2 and the process of S3 may be changed.

In S4, the mobile terminal 3 determines whether the user is getting on or off the bus 2 (the user is getting on the bus 2 or getting off the bus 2). More specifically, for example, the following three determining methods can be adopted. The mobile terminal 3 may combine these determining methods as needed to improve determination accuracy.

In the first method, the mobile terminal 3 is capable of acquiring a moving speed of the mobile terminal 3 based on GPS information from the GPS module 36. When the moving speed of the mobile terminal 3 is higher than a reference speed (for example, 20 km/h), the mobile terminal 3 is allowed to determine that the bus 2 is traveling (that is, the user is not getting on or off the bus 2). On the other hand, when the moving speed of the mobile terminal 3 is lower than the reference speed, the mobile terminal 3 is allowed to determine that the bus 2 is stopped (that is, the user is getting on or off (likely to getting on or off) the bus 2).

In the second method, the mobile terminal 3 may determine whether the user is getting on or off the bus 2 based on a detection result of the attitude sensor 37. When an operation that the user shows the digital ticket 333 to the crew of the bus 2 (for example, an operation that the user changes the orientation of the display 35 from the user side to the crew side by turning the mobile terminal 3) is detected, the mobile terminal 3 is allowed to determine that the user is getting on or off the bus 2. On the other hand, when such a user operation is not detected, the mobile terminal 3 is allowed to determine that the user is not getting on or off the bus 2.

In the third method, the mobile terminal 3 is capable of determining whether the mobile terminal 3 is located near a bus stop (a location to get on or off the bus 2) based on GPS information from the GPS module 36 (or a signal from a beacon receiver). When the mobile terminal 3 is closer than a predetermined distance to the bus stop (for example, within 30 m), the mobile terminal 3 is allowed to determine that the user is getting on or off the bus 2. On the other hand, when the mobile terminal 3 is farther than the predetermined distance from the bus stop, the mobile terminal 3 is allowed to determine that the user is not getting on or off the bus 2.

When the user is getting on or off the bus 2 (YES in S4), the mobile terminal 3 advances the process to S5. In S5, the mobile terminal 3 causes the display 35 to display the digital ticket 333 and an advertisement with a display area reduced as compared to a normal display area (see FIG. 5). After that, the mobile terminal 3 advances the process to step S7.

When the user is not getting on or off the bus 2 (NO in S4), the mobile terminal 3 advances the process to S6. In S6, the mobile terminal 3 causes the display 35 to display the digital ticket 333 and an advertisement with a normal display area (see FIG. 4). After that, the mobile terminal 3 advances the process to step S7.

In S7, the mobile terminal 3 determines whether the display 35 with a touch panel has received a user operation to end displaying the digital ticket 333 (a user operation to make a request to end displaying the digital ticket 333). When the mobile terminal 3 has not received the user operation (NO in S7), the mobile terminal 3 returns the process to S4. Thus, displaying the digital ticket 333 and the advertisement according to whether the user is getting on or off is continued. When the mobile terminal 3 has received the user operation (YES in S7), the mobile terminal 3 advances the process to S8.

In S8, the mobile terminal 3 ends displaying the digital ticket 333 and the advertisement on the display 35.

As described above, in the present embodiment, when the user is getting on or off the bus 2, the display area of an advertisement is adjusted so as to be smaller than the display area when the user is not getting on or off the bus 2. A situation in which the user is not getting on or off the bus 2, such as when the bus 2 is traveling, is suitable for the user to check details of an advertisement. Therefore, it is sufficiently significantly advantageous for the user to easily see the details of an advertisement by relatively increasing the display area of the advertisement. In contrast, when the user gets on or off the bus 2, the user shows the digital ticket 333 to a crew of the bus 2, so the user does not see the details of an advertisement. Therefore, the advantage in making it easy to see the digital ticket 333 with a reduced display area of an advertisement is greater than the disadvantage in making it difficult to see the details of the advertisement. Thus, according to the present embodiment, it is possible to achieve both the advantage of the digital ticket 333 and the advantage of advertisement display.

The embodiment described above is illustrative and not restrictive in all respects. The scope of the disclosure is not defined by the description of the above-described embodiment, and is defined by the appended claims. The scope of the disclosure is intended to encompass all modifications within the scope of the appended claims and equivalents thereof

What is claimed is:

1. A mobile terminal carried by a user, the mobile terminal comprising:
a display configured to display both a digital ticket to use transportation and an advertisement; and
a controller configured to control the display, wherein the controller is configured to control the display such that the digital ticket is displayed, and
when a predetermined condition indicating that the user is getting on or off the transportation is satisfied, control the display such that a display area of the advertisement reduces as compared to when the predetermined condition is not satisfied.

2. The mobile terminal according to claim 1, wherein the controller is configured to
when the predetermined condition is not satisfied, control the display such that both the digital ticket and the advertisement are displayed, and
when the predetermined condition is satisfied, control the display such that the digital ticket is displayed and the advertisement is not displayed.

3. The mobile terminal according to claim 1, further comprising a location detector configured to detect location information of the mobile terminal, wherein the controller is configured to
determine that the predetermined condition is satisfied when a moving speed of the mobile terminal is lower than a reference speed, and
determine that the predetermined condition is not satisfied when the moving speed of the mobile terminal is higher than the reference speed.

4. The mobile terminal according to claim 1, further comprising a sensor configured to detect rotational motion of the mobile terminal, wherein the controller is configured to
determine that the predetermined condition is satisfied when user operation that the user shows the digital ticket to a crew of the transportation is detected based on a detection result of the sensor, and
determine that the predetermined condition is not satisfied when the user operation is not detected.

5. The mobile terminal according to claim 1, further comprising a location detector configured to detect location information of the mobile terminal, wherein the controller is configured to
determine that the predetermined condition is satisfied when the location detector detects that the mobile terminal is closer than a predetermined distance to a getting on/off point of the transportation, and
determine that the predetermined condition is not satisfied when the location detector does not detect that the mobile terminal is closer than the predetermined distance to the getting on/off point.

6. A display method for a digital ticket for a user to use transportation, the display method comprising a displaying step of displaying both the digital ticket and an advertisement on a display of a mobile terminal, wherein
the displaying step includes, when a predetermined condition indicating that the user is getting on or off the transportation is satisfied, reducing a display area of the advertisement as compared to when the predetermined condition is not satisfied.

7. A non-transitory storage medium storing instructions executable on one or multiple processors in a mobile terminal and causing the one or multiple processors to execute the display method according to claim 6.
